(19) United States
(12) Patent Application Publication
(10) Pub. No.: US 2018/0302586 A1
(43) Pub. Date: Oct. 18, 2018

(54) ENDOSCOPE APPARATUS, ENDOSCOPE SYSTEM AND ENDOSCOPIC IMAGE DISPLAY CONTROL METHOD

(71) Applicant: OLYMPUS CORPORATION, Tokyo (JP)

(72) Inventor: Ryoji Motoki, Yokohama-shi (JP)

(73) Assignee: OLYMPUS CORPORATION, Tokyo (JP)

(21) Appl. No.: 15/949,448

(22) Filed: Apr. 10, 2018

(30) Foreign Application Priority Data
Apr. 13, 2017 (JP) 2017-079569

(51) Int. Cl. H04N 5/445; H04N 5/232

(52) U.S. Cl. CPC H04N 5/44504; H04N 2005/2255; H04N 5/23293; H04N 5/44591

(57) ABSTRACT

An endoscope apparatus includes an image sensor configured to pick up an image of a subject, and a controller configured to recognize a storage region configured to store a comparison image in accordance with a command for causing a display to display the comparison image and an endoscopic image acquired by the image sensor and to perform display control by reading a comparison image from the storage region recognized and displaying an image including the comparison image and the endoscopic image on the display.

### CROSS REFERENCE TO RELATED APPLICATION

This application claims the benefit of Japanese Application No. 2017-079569 filed in Japan on Apr. 13, 2017, the contents of which are incorporated herein by this reference.

### BACKGROUND

### 1. Technical Field

The present invention relates to an endoscope apparatus, an endoscope system and an endoscopic image display control method.

### 2. Background Art

Conventionally, endoscope apparatuses are widely used in industrial and medical fields. Endoscope apparatus users insert an elongated insertion portion into an inspection target and perform an endoscope inspection of the inspection target while viewing an endoscopic image displayed on a display.

A user who is an inspector may want to observe or determine an inspection region while comparing a desired image to be compared with an endoscopic image of the inspection target during an endoscope inspection.

For example, Japanese Patent Application Laid-Open Publication No. 2016-189812 proposes an endoscope apparatus configured to acquire an insertion amount of an insertion portion, the endoscope apparatus including a comparison function of displaying an endoscopic image acquired during an inspection side by side with a past endoscopic image acquired based on the insertion amount of the insertion portion on a display screen.

Furthermore, Japanese Patent Application Laid-Open Publication No. 2015-25965 proposes an endoscope apparatus including a comparison function of displaying a reference image, which is a comparison image, transparently and superimposed on a live image.

When the user wants to compare the live image with the comparison image, the user performs an operation of executing the comparison function and causes a display to display the comparison image.

### SUMMARY

An endoscope apparatus according to the present invention includes an image sensor configured to pick up an image of a subject, one or more controllers configured to recognize a storage region for storing a comparison image in accordance with a command for causing a display to display the comparison image and an endoscopic image acquired by the image sensor and perform display control by reading the comparison image from the storage region recognized by the recognition section and displaying an image including the comparison image and the endoscopic image on the display.

An endoscope system according to the present invention is an endoscope system including an endoscope apparatus and a server connected to the endoscope apparatus via a network, the endoscope apparatus including an image sensor configured to pick up an image of a subject, one or more controllers configured to recognize a storage region for storing a comparison image in accordance with a command for causing a display to display the comparison image and the endoscopic image acquired by the image sensor and perform display control by reading the comparison image from the storage region recognized by the recognition section and displaying an image including the comparison image and the endoscopic image on the display, and the server including a memory including the storage region.

An endoscopic image display control method according to the present invention includes recognizing a storage region for storing a comparison image in accordance with a command for causing a display to display the comparison image and an endoscopic image acquired by an image sensor configured to pick up an image of a subject, reading the comparison image from the recognized storage region and displaying an image including the comparison image and the endoscopic image on the display.

### BRIEF DESCRIPTION OF THE DRAWINGS

FIG. 1 is a perspective view illustrating a schematic configuration of an endoscope apparatus according to an embodiment of the present invention;

FIG. 2 is a block diagram illustrating an internal configuration of an endoscope apparatus 1 according to the embodiment of the present invention;

FIG. 3 is a block diagram illustrating a configuration of a comparison image display control section 31d according to the embodiment of the present invention;

FIG. 4 is a diagram illustrating an image display example displayed on a display 14 when execution of a comparison function according to the embodiment of the present invention is instructed;

FIG. 5 is a flowchart illustrating an example of a comparison image folder generation processing flow according to the embodiment of the present invention;

FIG. 6 is a diagram illustrating a folder structure for storing image data stored in a memory 33 of the endoscope apparatus 1 according to the embodiment of the present invention; and

FIG. 7 is a flowchart illustrating an example of a comparison function processing flow according to the embodiment of the present invention.

### DETAILED DESCRIPTION OF PREFERRED EMBODIMENT

Hereinafter, an embodiment of the present invention will be described with reference to the accompanying drawings.

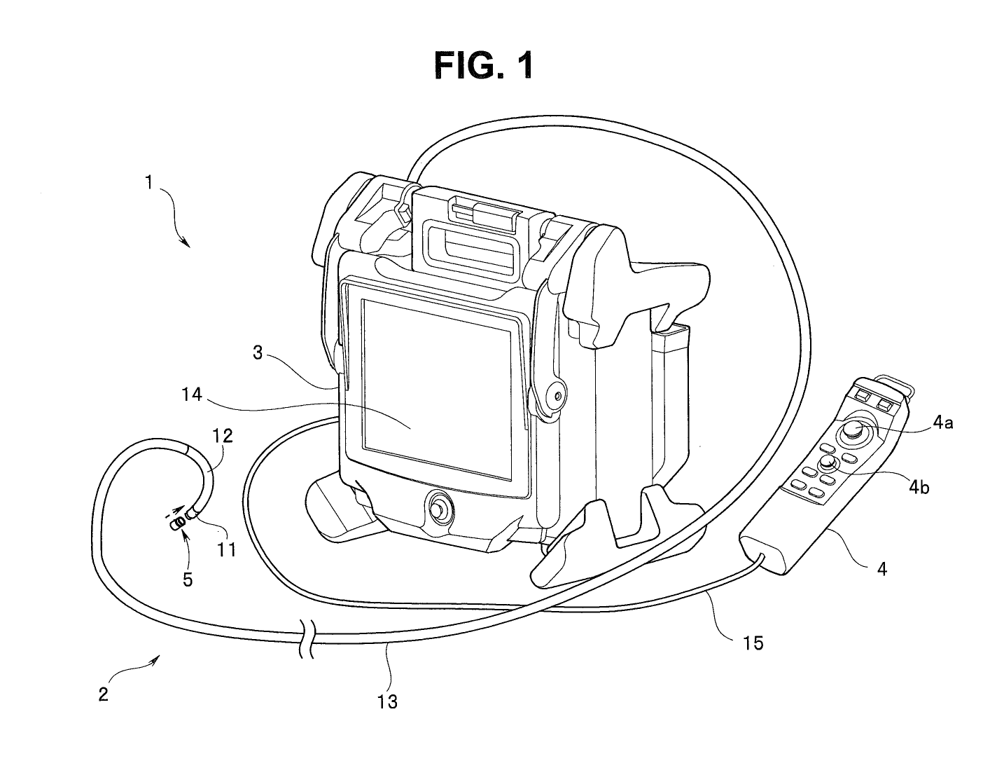

FIG. 1 is a perspective view illustrating a schematic configuration of an endoscope apparatus according to an embodiment.

The endoscope apparatus 1 is configured to include an elongated insertion portion 2, a body section 3 and an operation portion 4. The insertion portion 2 is configured to include a distal end portion 11, a bending portion 12 and a flexible tube portion 13 connected in order from a distal end side. A proximal end of the flexible tube portion 13 is detachably connected to the body section 3. That is, the insertion portion 2 is detachably connected to the body section 3. The distal end portion 11 is provided with an objective optical system and an image pickup device as will be described later.

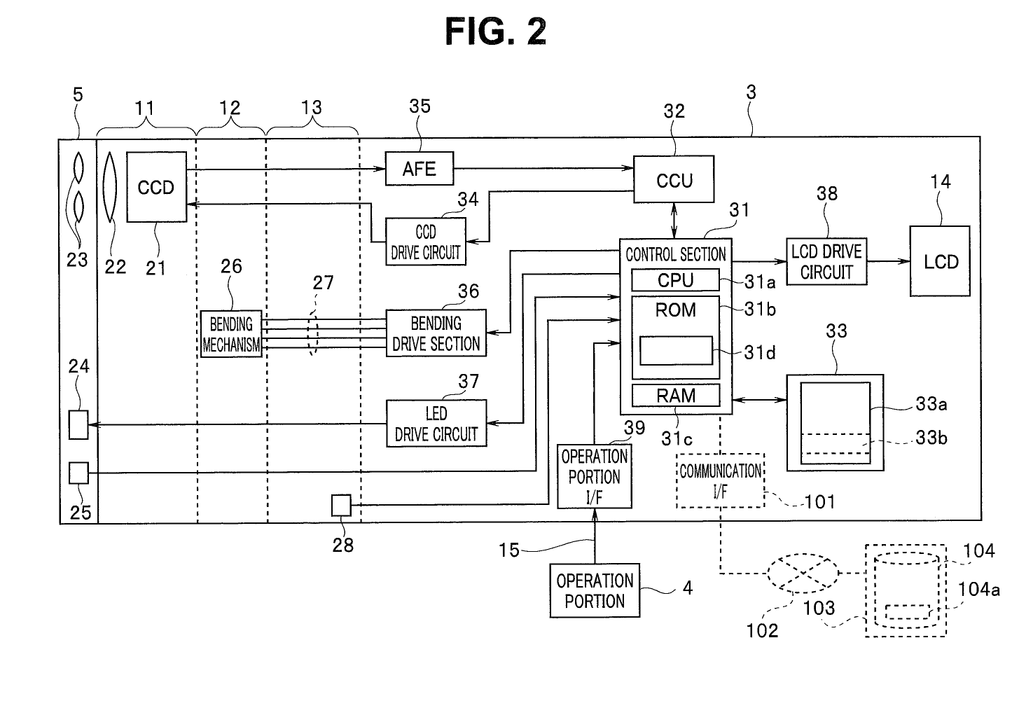

The body section 3 includes a control section 31 (see FIG. 2) configured to control an overall operation of the endoscope apparatus 1 and a liquid crystal display device (hereinafter referred to as “LCD”) 14 which is a display. Endoscopic images picked up by the image pickup device of the distal end portion 11 and a menu screen or the like for the user to execute various functions are displayed on the screen of the LCD 14.

An optical adapter 5 is detachably attached to the distal end portion 11 of the insertion portion 2 as shown by a dotted-line arrow. The optical adapter 5 includes an optical system and a light-emitting section as will be described later. There are a plurality of types of the optical adapter 5 such as an adapter for changing a view direction and an adapter for measurement processing. The user attaches the optical adapter 5, selected according to a purpose and a method or the like of inspection, to the distal end portion 11.

The operation portion 4 is connected to the body section 3 via a cable 15. The operation portion 4 is a remote controller and includes a plurality of operation members such as various operation buttons, and two joysticks 4a and 4b. The operation buttons include a freeze button to display a still image, a recording button to instruct recording and a determination button to instruct determination or selection or the like. The joystick 4a is an operation member for an operation to cause the bending portion 12 to bend in a desired direction and the joystick 4b is an operation member for an operation to move a selected item on a menu screen or move a measurement point or the like.

Note that a touch panel may be attached to the LCD 14 so that the user may touch buttons or the like displayed on a screen with a finger and thereby give an operation and an instruction to the endoscope apparatus 1 together with or instead of the operation portion 4.

FIG. 2 is a block diagram illustrating an internal configuration of the endoscope apparatus 1.

A CCD image sensor (hereinafter referred to as a “CCD”) 21 as an image pickup device is provided at the distal end portion 11. An objective optical system 22 including a plurality of lenses is disposed on a distal end side of the CCD 21. The CCD 21 configures an image sensor configured to pick up an image of a subject.

Here, the optical adapter 5 mounted on the distal end portion 11 is a measurement adapter. The optical adapter 5 includes a lens system 23 that forms part of the objective optical system, a light-emitting diode (hereinafter referred to as an “LED”) 24 which is a semiconductor light-emitting device and a non-volatile memory 25.

The lens system 23 includes two stereo measurement lenses. The LED 24 is a light-emitting section configured to emit illumination light from an illumination window which is not shown. Information on such as a type and a model of the optical adapter 5 is recorded in the memory 25.

When the optical adapter 5 is attached to the insertion portion 2 and a proximal end portion of the insertion portion 2 is connected to the body section 3, the information recorded in the memory 25 can be acquired by the control section 31, which will be described later, via a signal line provided in the insertion portion 2 and the body section 3.

The bending portion 12 includes a bending mechanism 26 configured of a plurality of pieces. Distal end portions of four bending wires 27 for bending in four directions of up, down, left and right are fixed to a most distal end piece of the bending mechanism 26. The four bending wires 27 are inserted into the flexible tube portion 13.

A non-volatile memory 28 is provided at a proximal end portion of the insertion portion 2. The memory 28 records information on a type, a model or the like of the insertion portion 2.

When the proximal end portion of the insertion portion 2 is connected to the body section 3, the information recorded in the memory 28 can be acquired by the control section 31, which will be described later, via a signal line provided in the body section 3.

The body section 3 includes the control section 31, a camera control unit (hereinafter referred to as a “CCU”) 32, a memory 33, a CCD drive circuit 34, an analog front end (hereinafter referred to as an “AFE”) 35, a bending drive section 36, an LED drive circuit 37, an LCD drive circuit 38 and an operation portion interface circuit (hereinafter referred to as an “operation portion I/F”) 39.

The control section 31 includes a central processing unit (hereinafter referred to as a “CPU”) 31a, a ROM 31b, a RAM 31c and the like and is configured to control operations of various functions of the endoscope apparatus 1. The ROM 31b stores a plurality of programs corresponding to various functions, and, when a function to be executed is specified by the user, the CPU 31a reads a program corresponding to the function from the ROM 31b, develops the program on the RAM 31c and executes the program.

The ROM 31b also stores a program of a comparison image display control section 31d. The comparison image display control section 31d is a program stored in the ROM 31b here, but the comparison image display control section 31d may also be configured of a circuit.

The comparison image display control section 31d implements a comparison function that displays a comparison image and a live image arranged side by side. The comparison function will be described later.

Note that the ROM 31b stores, in addition to the program of the comparison image display control section 31d, various programs such as a display processing program that displays an endoscopic image from the CCU 32 on the LCD 14, a recording processing program that records image data of the endoscopic image from the CCU 32 in the memory 33, a playback processing program that reads and plays back the image data of the endoscopic image recorded in the memory 33 and causes the display 14 to display the image data and a menu processing program that displays a menu screen based on an instruction from the user. Therefore, the user can operate the operation portion 4 to display an endoscopic image of a live image on a screen 14a and display a menu screen and can also instruct execution of the comparison function during execution of the measurement function.

The CCU 32 is a circuit that receives an image pickup signal from the CCD 21 and generates an endoscopic image. The CCU 32 generates a drive signal for the CCD drive circuit 34 and outputs the drive signal under the control of the control section 31. The CCU 32 receives an image pickup signal from the AFE 35 under the control of the control section 31, generates an endoscopic image which is a live image and outputs the live image to the control section 31.

The memory 33 is a memory card incorporating a rewritable non-volatile memory, for example, a flash memory. Here, the memory 33 can be detachably attached to the endoscope apparatus 1. The memory 33 includes a storage region 33a that can store data such as images. The user operates the operation portion 4 and can thereby record a still image or a moving image of the endoscopic image in the memory 33.

As will be described later, the storage region 33a includes a comparison image storage region 33b shown by a dotted line. As will be described later, the comparison image storage region 33b is a region in which image data of a comparison image folder is stored. As will be described later, the comparison image folder corresponding to the comparison image storage region 33b may be set in advance or may be set by the user.

Recording or reading of an image into/from the memory 33 is performed under the control of the control section 31.

The CCD drive circuit 34 is connected to the CCD 21 via a signal line, generates various drive signals to drive the CCD 21 and outputs the drive signals to the CCD 21.

The AFE 35 is connected to the CCD 21 via a signal line. The AFE 35 receives an image pickup signal which is an analog signal from the CCD 21, converts the analog image pickup signal to a digital signal, applies processing such as noise cancellation and outputs the image pickup signal to the CCU 32.

The bending drive section 36 includes a motor and a mechanism for traction and loosening of each bending wire 27. The bending drive section 36 performs traction and loosening of each bending wire 27 using the motor under the control of the control section 31. When the user operates the joystick 4a, the control section 31 receives an operation signal of the joystick 4a of the operation portion 4 and outputs a drive signal to the motor according to the operation signal.

The LED drive circuit 37 operates under the control of the control section 31, generates a drive signal and outputs the drive signal to the LED 24. The LED 24 emits light in accordance with the drive signal and the light of the LED 24 is emitted from an illumination window (not shown) as illumination light.

The LCD drive circuit 38 receives an image signal from the control section 31 and outputs the image signal to the LCD 14.

The operation portion I/F 39 is a circuit that generates operation signals indicating operations on the various operation buttons, the joysticks 4a and 4b of the operation portion 4 and outputs the operation signals to the control section 31.

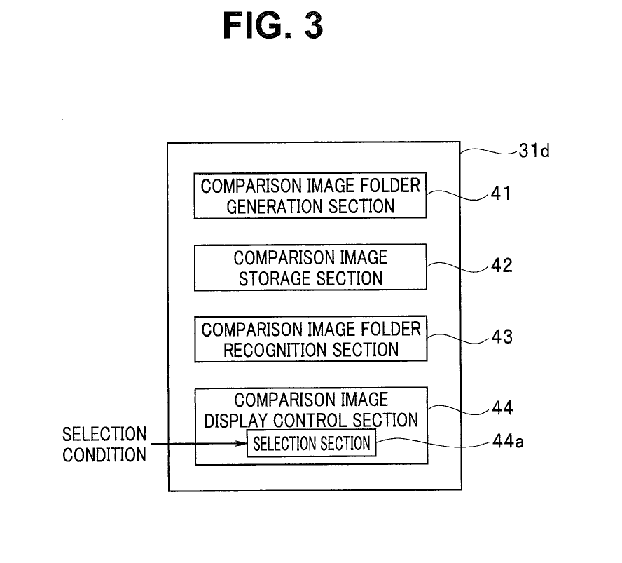

Next, a configuration of the comparison image display control section 31d configured to implement the comparison function of the endoscope apparatus 1 will be described. FIG. 3 is a block diagram illustrating the configuration of the comparison image display control section 31d.

The comparison image display control section 31d includes a comparison image folder generation section 41, a comparison image storage section 42, a comparison image folder recognition section 43 and a comparison image display control section 44. The comparison image display control section 44 includes a selection section 44a.

The comparison image folder generation section 41 is a processing program to allow the user to create a dedicated folder for storing a comparison image. That is, the comparison image folder generation section 41 is a processing section configured to create a folder that stores data of a file of the comparison image such as a past inspection image. The folder that stores the data of the file of the comparison image (hereinafter referred to as a “comparison image folder”) is a folder corresponding to the comparison image storage region 33b that can store one or two or more image data files. The user can create and set a comparison image folder at a predetermined position in a tree-type directory by the comparison image folder generation section 41.

Since the comparison image folder is used to read the comparison image during execution of the comparison function, the comparison image folder is given a predetermined folder name.

Note that the comparison image folder may be set in advance at a predetermined position in the tree-type directory. For example, it is possible to connect the memory 33, which is a portable medium, to an external personal computer, create a comparison image folder at a predetermined position in the memory 33, more specifically, at a predetermined position in the tree-type directory, and thereby set a comparison image folder corresponding to the comparison image storage region 33b of the memory 33. That is, the memory 33 includes a storage region corresponding to the comparison image folder.

The comparison image storage section 42 is a processing program for the user to store a comparison image. That is, the comparison image storage section 42 is a processing section that stores one or two or more comparison images in a comparison folder.

When the user stores and registers a comparison image, read when a comparison function is executed, in a comparison image folder in advance, the user causes a folder tree to be displayed on the screen 14a of the LCD 14, copies a comparison image stored in another folder to the comparison image folder, and can thereby store one or two or more comparison images in the comparison folder.

The comparison image folder recognition section 43 is a processing program for recognizing the comparison image folder. As will be described later, when the comparison function is executed, the comparison image folder recognition section 43 searches for and recognizes the comparison image folder. For example, the comparison image folder recognition section 43 performs a process of determining whether a comparison image folder having a predetermined folder name exists in a directory or not.

The comparison image display control section 44 is a processing section configured to generate and output image data of the comparison image and an image including a live image (hereinafter referred to as a “comparison function image”). That is, the comparison function image is displayed on the screen 14a as an image in which the comparison image and the live image are arranged side by side.

When the comparison image folder is preset in the directory, the comparison image storage section 42 stores the comparison image in the preset comparison image folder and the comparison image display control section 44 reads the comparison image from the preset comparison image folder.

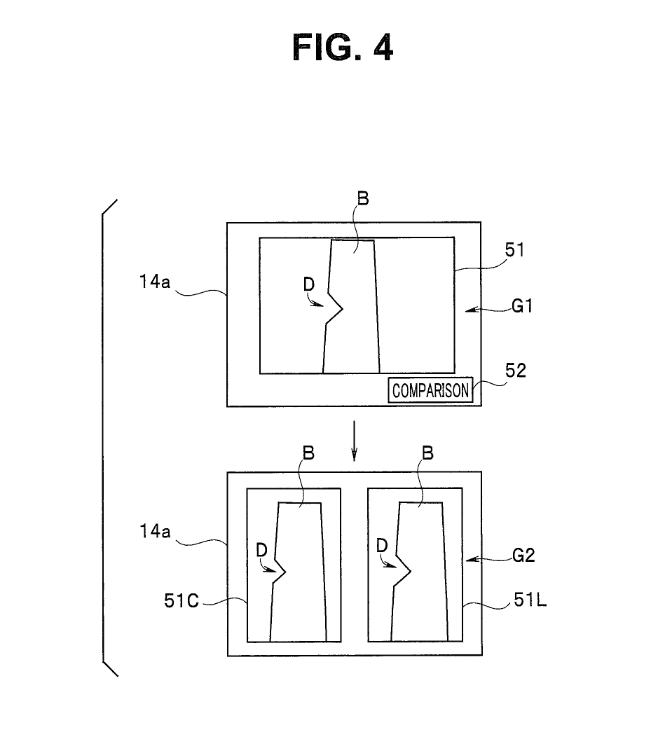

FIG. 4 is a diagram illustrating an image display example displayed on the display 14 when execution of the comparison function is instructed.

When the user is observing an endoscopic image and when the measurement function is being executed, the user can instruct execution of the comparison function. FIG. 4 illustrates transition of screens displayed on the screen 14a of the display 14.

A top image G1 in FIG. 4 is an image showing an endoscopic image before execution of the comparison function is instructed, has one image display region 51 and the endoscopic image which is a live image is displayed in the image display region 51. The image G1 also displays a comparison button 52 for instructing execution of the comparison function. FIG. 4 illustrates an endoscopic image including a blade B in an aircraft engine which is an inspection target in the image display region 51.

The user can select the comparison button 52 and instruct execution of the comparison function through an operation such as locating a cursor displayed on the screen 14a on the comparison button 52 and pressing the determination button of the operation portion 4.

When the execution of the comparison function is instructed, a bottom image G2 in FIG. 4 is displayed on the screen 14a instead of the image G1. The image G2 includes two image display regions 51L and 51C to display two images, and is a comparison function image in which the endoscopic image which is a live image and the comparison image are displayed arranged side by side in the two image display regions 51L and MC.

The endoscopic image 51L is a live image obtained through image pickup by the CCD 21. The comparison image displayed on the image display region 51C is a past endoscopic image read from the comparison image storage region 33b of the memory 33 corresponding to the comparison image folder.

Thus, the user executes the comparison function and can thereby compare the live image with the past image and determine the state of the inspection target.

To be more specific, in the case of FIG. 4, for example, the user cannot determine a change in the size of a notch D generated in the blade B of the aircraft engine which is the inspection target by only viewing the endoscopic image displayed in the image display region 51 of the image G1, but with a comparison between the comparison image displayed in the image display region 51C and the live image displayed in the image display region 51L arranged side by side by the comparison function, the user can determine the degree of the change in the size of the notch D in a lapse of time from the past inspection to the present time.

Note that in the case of FIG. 4, there is only one display region 51C in which the comparison image is displayed, but there can be two or more display regions 51C.

When there are a plurality of comparison images in the comparison image folder, the selection section 44a is a processing section configured to select a comparison image to be displayed in the image display region 51C from among a plurality of comparison images according to a set selection condition. The user can set and input the selection condition to the selection section 44a. The selection condition data is stored in the storage region in the memory 33 managed by the selection section 44a.

By operating the operation portion 4, the user can input, for example, specification of a date, ascending order or descending order of dates and times to the selection section 44a as the selection condition.

Note that the selection condition may include system configuration information, measurement information, additional information, file name information, image information, file type information, file position information, folder specification information or the like.

The system configuration information is information such as model information of the body section that configures the endoscope apparatus 1 and model information of the adapter.

The measurement information is information on measurement of the endoscopic image obtained through measurement using the measurement function, and is information on the measurement method, measurement location (position, the number), measurement result and the like.

The additional information is information added by the user to the endoscopic image and is information on such as various comments and information related to inspection results.

The file name information is information on the file name of a file of the endoscopic image.

The image information is information on a video format, video size, frame rate or the like of the endoscopic image.

The file type information is type information such as a still image, moving image, image with speech, three-dimensional image.

The file position information is information on the position of the comparison image folder to be used when a plurality of comparison image folders are set, for example, information for specifying the memory 33 of the body section 3 or a memory in an apparatus on a network.

The folder specification information is information on the comparison image folder name to be used when a plurality of comparison image folders such as a folder storing normal-state images or a folder storing images of the previous inspection results are set.

When a comparison image is selected according to a selection condition, the selection condition may not only be totally matched but also be partially matched, and in that case, a comparison image is selected in descending order of the degree of matching.

When the optical adapter 5 for measurement is attached to the distal end portion 11, the control section 31 executes a measurement processing program, generates an image signal corresponding to the measurement processing and outputs the image signal to the LCD 14. The user can instruct the comparison function of displaying the comparison image and the live image arranged side by side during execution of the measurement function.

When the user instructs execution of the comparison function, the comparison image folder recognition section 43 executes a search to recognize a comparison image folder, the comparison image display control section 44 extracts a comparison image from the comparison image folder according to the selection condition of the selection section 44a, generates a comparison function image and outputs the image signal. The extracted comparison image is displayed in the image display region 51C of the comparison function image.

### (Operation)

Next, a display control process on the comparison function image will be described.

First, a process of generating a comparison image folder for the comparison image storage region 33b will be described.

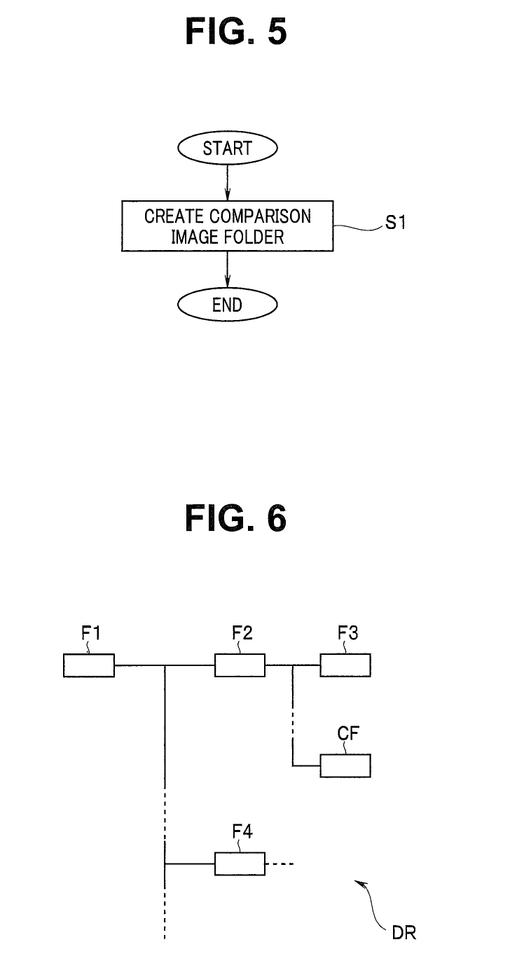

FIG. 5 is a flowchart illustrating a comparison image folder generation processing flow. The processing in FIG. 5 is executed by the comparison image folder generation section 41.

When the user performs a predetermined operation on the operation portion 4 and thereby selects and executes a process of generating a comparison image folder from a predetermined menu screen, the comparison image folder generation section 41 is executed.

The comparison image folder generation section 41 creates a comparison image folder based on the user's instruction (step (hereinafter abbreviated as “S”) 1). As described above, the comparison image folder is created and set in accordance with the comparison image storage region 33b.

FIG. 6 is a diagram illustrating a folder structure storing image data stored in the memory 33 of the endoscope apparatus 1. As shown in FIG. 6, a directory DR is composed of a plurality of folders and a plurality of folders having a hierarchical structure are set under a root directory F1. In the case of FIG. 6, a folder F2 is set under the root directory F1, and a plurality of folders F3 and CF are set at the same hierarchical level under the folder F2. The folder CF is a comparison image folder.

For example, when the folder F2 is a folder that stores an endoscopic image file of a certain inspection target, the endoscopic image file acquired during the inspection at that time is stored in the folder F3. In the case of FIG. 6, the comparison image folder CF is set at the same hierarchical level as the folder F3 under the folder F2.

The user can store the comparison image file in the comparison image folder CF generated by the comparison image folder generation section 41.

That is, the comparison image folder generation section 41 configures a folder generation section that generates a folder for storing the comparison image file in the storage region 33b in the memory 33 which is a storage apparatus.

The comparison image storage section 42 stores the data file of the comparison image in the comparison image folder CF. More specifically, when the user performs a predetermined operation on the operation portion 4 to thereby select and execute a comparison image storing process from a predetermined menu screen, the user can store a data file of a comparison image to be used during an inspection in the comparison image folder CF.

Next, a process when the comparison function is executed during an endoscope inspection will be described.

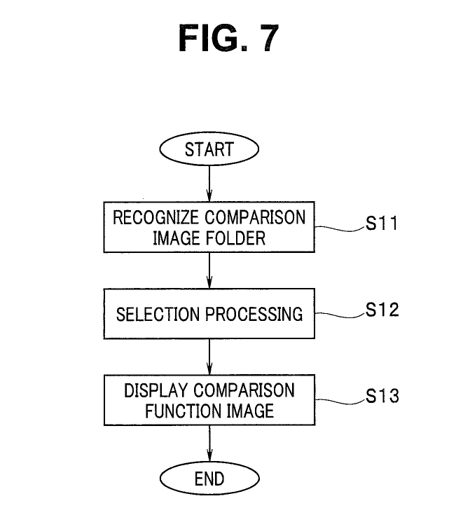

FIG. 7 is a flowchart illustrating an example of a comparison function processing flow. The process in FIG. 7 is performed by the comparison image folder recognition section 43 and the comparison image display control section 44.

When the user selects the aforementioned comparison button 52 and instructs execution of the comparison function, the process in FIG. 7 is executed.

First, the comparison image folder recognition section 43 executes a recognition process on the comparison image folder (S11). In S11, it is determined whether there is any comparison image folder set in the memory 33. When there is a comparison image folder CF set in the directory, it is determined that the comparison image folder exists. When there is no comparison image folder CF set in the memory 33, it is determined that there is no comparison image folder.

That is, the comparison image folder recognition section 43 configures a recognition section configured to search and recognize a storage region corresponding to a dedicated comparison image folder storing the comparison image in accordance with a command for causing the LCD 14 to display the comparison image and the endoscopic image acquired by the CCD 21.

Next, the comparison image display control section 44 executes a selection process (S12). In the selection process, one comparison image is selected and read from among one or two or more image data files stored in the comparison image folder CF recognized in S11 according to the selection condition set in the selection section 44a.

The comparison image display control section 44 generates image data of the image G2 in FIG. 4 using the read comparison image, outputs the image data to the LCD drive circuit 38 and displays the comparison function image (S13). More specifically, the comparison image display control section 44 generates the image G2 in FIG. 4 based on the comparison image selected and read in S12 and the live image from the CCU and outputs the image data of the image G2 to the LCD drive circuit 38. As a result, the image G2 in FIG. 4 is displayed on the screen 14a of the LCD 14.

Note that when only one comparison image is selected by the selection section 44a, only the comparison image is displayed in the image display region 51C. When a plurality of comparison images are selected by the selection section 44a, one comparison image selected according to the degree of matching is displayed in the image display region 51C from among the comparison images selected according to the selection condition. In that case, the user operates a predetermined operation member of the operation portion 4, for example, the joystick 4b and can thereby display a comparison image determined as having a next higher degree of matching with respect to the comparison image currently being displayed or a comparison image determined as having a next lower degree of matching with respect to the comparison image currently being displayed in the image display region 51C.

Note that when there are two or more display regions 51C in which a comparison image is displayed, two or more comparison images having a high degree of matching are displayed in a plurality of display regions 51c.

That is, the comparison image display control section 44 configures a display control section configured to perform display control by reading a comparison image from a storage region recognized by the comparison image folder recognition section 43 and displaying an image including the comparison image and the endoscopic image on the LCD 14 which is a display.

When there are a plurality of comparison images, the selection section 44a selects a comparison image to be read from a storage region corresponding to the comparison image folder according to a predetermined selection condition, and the comparison image display control section 44 reads the comparison image selected by the selection section 44a and performs display control.

As described above, according to the aforementioned embodiment, it is possible to provide an endoscope apparatus and an endoscopic image display control method that can easily display a comparison image.

The user only needs to store and register an image to be used as a comparison image in the comparison image folder in advance, and when the user executes the comparison function during an inspection, the comparison image registered in advance is automatically displayed from the comparison image folder.

When a plurality of comparison images are registered in the comparison image folder CF, a comparison image selected according to a predetermined selection condition is displayed in the image display region 51C of the image G2. Since the degree of matching is determined depending on the selection condition, when another comparison image is displayed in the image display region 51C of the image G2, the user operates the joystick 4b of the operation portion 4, and can thereby display the next comparison image in the image display region 51C.

Thus, the user needs only to register the comparison image in the comparison image folder CF dedicated to the comparison image to display the comparison image in the image G2 which is a comparison function image, thus making a complicated operation unnecessary.

Next, modifications of the aforementioned embodiment will be described.

### (Modification 1)

In the aforementioned embodiment, one comparison image folder CF is set in the memory 33 of the endoscope apparatus 1, but a plurality of comparison image folders CF may be enabled to be created and set in the directory DR.

For example, a plurality of comparison image folders CF may be enabled to be set under one inspection target folder or a plurality of comparison image folders CF may be enabled to be set in a folder for each inspection target region.

In that case, one comparison image folder to be made active or used is selected from among the plurality of comparison image folders based on a selection condition.

### (Modification 2)

In the aforementioned embodiment, a comparison image is displayed side by side with a live image as the comparison function. However, as disclosed, for example, in Japanese Patent Application Laid-Open Publication No. 2015-25965, it may be possible to display a comparison image having non-zero transmittance superimposed on a live image. Even when a thinly transparent comparison image is superimposed on a live image, the user can determine the state of an inspection region.

### (Modification 3)

A comparison image folder may be set in a predetermined storage region of a predetermined storage section in a server connected to the endoscope apparatus 1 via a network or set in the server in advance.

In this case, as shown by a dotted line in FIG. 2, the body section 3 includes a communication interface (I/F) 101. The communication interface 101 is connected to be communicable with a server 103 via a network 102 such as the Internet. The server 103 includes a storage apparatus 104 and a storage region 104a for the comparison image folder CF is set in the storage apparatus 104. That is, a memory having a storage region corresponding to the comparison image folder is provided in the server 103 connected to the network 102.

The comparison image storage section 42 stores a comparison image file in the storage region 104a set in the server 103 corresponding to the comparison image folder CF and the comparison image display control section 44 reads the comparison image from the storage region 104a set in the server 103 corresponding to the comparison image folder CF.

The present invention is not limited to the aforementioned embodiment, but can be changed or modified or the like in various ways without affecting the spirit and scope of the present invention.

What is claimed is:

1. An endoscope apparatus comprising:
an image sensor configured to pick up an image of a subject;
one or more controllers configured to
recognize a storage region for storing a comparison image in accordance with a command for causing a display to display the comparison image and an endoscopic image acquired by the image sensor; and
perform display control by reading the comparison image from the storage region recognized by the recognition section and displaying an image including the comparison image and the endoscopic image on the display.

2. The endoscope apparatus according to claim 1,
wherein the one or more controllers are configured to:
select a comparison image which is read from the storage region when the comparison image exists in plurality; and
perform the display control by reading the comparison image.

3. The endoscope apparatus according to claim 1, wherein the one or more controllers are configured to generate in a storage apparatus, a folder for storing a file of the comparison image in the storage region.

4. The endoscope apparatus according to claim 1, comprising a memory including the storage region.

5. The endoscope apparatus according to claim 1, wherein a memory including the storage region is provided in a server connected to a network.

6. An endoscope system comprising:
an endoscope apparatus; and
a server connected to the endoscope apparatus via a network, wherein
the endoscope apparatus comprises:
an image sensor configured to pick up an image of a subject;
one or more controllers configured to
recognize a storage region for storing a comparison image in accordance with a command for causing a display to display the comparison image and an endoscopic image acquired by the image sensor; and
perform display control by reading the comparison image from the storage region recognized by the recognition section and displaying an image including the comparison image and the endoscopic image on the display, and
the server comprises a memory including the storage region.

7. An endoscopic image display control method comprising:
recognizing a storage region for storing a comparison image in accordance with a command for causing a display to display the comparison image and an endoscopic image acquired by an image sensor configured to pick up an image of a subject; and
reading the comparison image from the recognized storage region and performing display control to display an image including the comparison image and the endoscopic image on the display.
